(19) United States
(12) Patent Application Publication
(10) Pub. No.: US 2026/0153586 A1
(43) Pub. Date: Jun. 4, 2026

(54) Detection Apparatus and Method

(71) Applicant: Malcolm Edwin Whittaker, Houston, TX (US)

(72) Inventor: Malcolm Edwin Whittaker, Houston, TX (US)

(21) Appl. No.: 18/967,056

(22) Filed: Dec. 3, 2024

(51) Int. Cl. G01S 1/08; G01S 1/04

(52) U.S. Cl. CPC G01S 1/08; G01S 1/045

(57) ABSTRACT

A detection device for determining the number of passengers in a vehicle, comprising: an antenna for receiving a signal from an electronic device; a device for determining the number of electronic devices found within the vehicle using the signal from the electronic device located within the vehicle; and, a transceiver configured to communicate the number of electronic devices to a recipient.

### CROSS-REFERENCE TO RELATED APPLICATIONS

None.

### STATEMENT REGARDING FEDERALLY SPONSORED RESEARCH Not Applicable.

### BACKGROUND OF THE INVENTION

As the name implies, forward looking infrared cameras are used to sense infrared radiation in front of the infrared camera. Forward looking infrared cameras are typically referred to as FLIR cameras or a FLIR camera. FLIR is used in a wide variety of law enforcement, industrial, and security settings. For example, as seen in FIG. 1, a law enforcement helicopter H may have a FLIR camera mounted on or near the underbody of a police helicopter. As stated above, the FLIR camera can detect infrared radiation, also known as IR. An example of an infrared detection device is U.S. Pat. No. 6,077,044 issued on Mar. 16, 2004 for an “Infrared Camera System.” Human beings emit infrared radiation. This is commonly thought of as “body heat.” Police helicopters'FLIR systems can identify the location of a person who is not visible to the naked eye by detecting the person's infrared signature, i.e., sensing the “body heat” or warmth all living humans, and all mammals, emit. To a certain extent, a dead person will continue to emit infrared radiation until their body temperature declines to the ambient temperature. This phenomenon is also referred to as blackbody thermal radiation. Any object at a given temperature radiates light, and the object's temperature determines how much radiation is emitted. The temperature also determines the wavelength. Hotter objects emit shorter wavelengths more intensely, compared with those emitted by cooler objects. For example, a camp fire's flames appear to be red or orange to the human eye. The temperatures associated with visible light are typically greater than 1,000 degrees Centigrade, while objects at cooler temperatures emit in the infrared bands. Without a device that enables them to do so, a human can only see light in the visible range. The ability to detect an infrared signature can locate a hidden vehicle, as long as the engine has not cooled to the ambient temperature. This ability to measure infrared signature can be used to make highly accurate traffic data analysis of both vehicles and people. To a certain extent, depending how thick and insulated a wall is, FLIR can detect a heat source such as a water leak or missing insulation without having to open the wall. FLIR can also “see through” smoke and fog by sensing infrared radiation. This is particularly useful for safely steering a vehicle or boat in fog or smoke or when searching for a person inside a smoke-filled building. Phrased differently, the visible light spectrum is obscured by the fog and smoke, but the infrared radiation, commonly referred to as “IR,” can still be detected by FLIR. However, a surface that is reflective defeats FLIR's infrared radiation (IR) sensing ability. For example, a FLIR camera pointed at a glass wall would only sense the reflection of its own infrared radiation (IR). See FIG. 2. Phrased differently, a FLIR camera pointed at a glass window would detect its own infrared radiation (IR) signature, not that of the person or object on the other side of the window.

Many police helicopters H have a mounted FLIR unit that can detect the infrared radiation (IR) produced by a person's radiated body heat. See FIG. 1. These police FLIR units are relatively common and are frequently used by police aerial units, typically helicopters, when searching for a person. In addition to the infrared detector, FLIR units commonly have a camera and can be steered, either by a human operator or a software driven automated system, to track a person or automobile. Software allows an operator to “lock on” to a moving person or automobile and the software continuously tracks the person or automobile while they are fleeing or moving by pointing the FLIR unit to automatically lock on to and track the individual or vehicle. This is an important feature because the helicopter could be traveling at as much as 120 miles per hour and will typically stay on station by orbiting around the person or vehicle, whether they are moving or stationary. For purposes of clarity, the helicopter can also hover to stay on station. However, hovering consumes significantly more fuel and can limit flight endurance for the helicopter. This lock on feature allows the FLIR unit to not lose the location of the person or vehicle. The camera component of the FLIR unit can also record for later training or use as evidence.

As discussed above, a weakness of the FLIR system is that it cannot see through glass or metal. Therefore, a FLIR system can follow a vehicle, but it cannot detect the thermal infrared radiation (IR) emitted by the passengers. Phrased differently, the passenger's thermal infrared radiation (IR) is reflected inwardly and is not sensed by the FLIR system. This means that the FLIR system cannot detect the number of occupants inside a vehicle. This can be problematic if only a single patrol unit with only one law enforcement officer inside is following a vehicle with multiple occupants. Phrased differently, the FLIR unit cannot detect the number of occupants in the vehicle. If the vehicle stops and the occupants flee on foot, there may be insufficient law enforcement officers to successfully pursue all of the occupants of the vehicle. Therefore, it would be desirable for the FLIR unit to detect the number of occupants in a vehicle in order to have sufficient law enforcement officers to detain all of the occupants. Thus, a device that could detect the number of occupants of a vehicle would be highly desirable for law enforcement officer safety. In the same way, it would be highly desirable for a law enforcement officer pursuing a vehicle to know the number of occupants in the vehicle. In this way, the officer could request the assistance of back up units to ensure sufficient law enforcement officers are present to detain all of the vehicle occupants. It would also be highly desirable to identify the occupants. The present device addresses these issues.

In the case of Kyllo v. United States, 533 U.S. 27(2001 ) the United States Supreme Court decided that it was constitutional for police to collect infrared radiation without a warrant. Thus, the present apparatus and method will not implicate unconstitutional search issues.

FIGS. 3A and 3B illustrate a conventional (prior art) mobile phone network N. It is known that a mobile phone, which could include other such devices as a tablet, smart watch, or other similar device, referred to broadly as mobile phone MS communicates radio waves/signals S to communicate with a cell tower T. A base transceiver stations BTS is part of cell tower T. These radio waves S are part of the electromagnetic spectrum and are used to send and receive signals between phone MS and nearby cell towers T. Typically, cell phones MS communicate with cell phone tower T in the frequency range of 824-890 MHz and 1850-1990 MHz. More modern cell phones typically use higher frequencies. Some carriers may, at times, use frequencies as high as 39 GHz and as low as 600 MHz. Unlike a conventional landline telephone, a mobile phone/mobile subscriber MS is, as is apparent from the name, mobile. As mobile phone MS moves, the phone communicates with nearby cell towers T. This occurs even if the person is not using the cell phone, i.e., talking on his or her cell phone MS. Phrased differently, a cell phone MS is in communication with at least one cell tower T at all times, unless it is powered down. FIG. 3A illustrates that a call is connected to other telephones through the Public Switching Telephone Network (PSTN). Phrased differently, the cell phone MS can communicate with the PSTN and route calls to other phones, landlines and other cell phones, in this way. Currently, a variety of systems are used to enable cell phone calls. Examples of these systems are FDMA, TDMA, CDMA, and GSM. FIGS. 3A and 3B also illustrate that the mobile user's phone MS is “handed off” between cell towers T as the mobile user MU moves about. The cell tower's base transceiver station (BTS) handles radio communication with cellphones. It converts radio signals to digital signals. The Base Station Controller (BSC) manages multiple BTSs. It handles the allocation of resources, like frequencies and power, and ensures seamless handoffs when a phone moves from one cell to another, often referred to as a “handoff,” between cell towers T. The Mobile Switching Center (MSC) connects calls (and texts) between users by routing them through the cellular network N. It manages all aspects of calls, including setup, routing, and termination of mobile calls.

However, in each of these systems, the cell phone MS has a unique IMEI (International Mobile Equipment Identity) and also a serial number commonly referred to as the IMSI. This IMEI number helps identify the make and model of the phone and can be used to track or block a stolen phone. On the other hand, the IMSI (International Mobile Subscriber Identity) number is the SIM card number that is 14-15 digits long and contains the country code. The Mobile Station International Subscriber Directory Number (MSISDN) is a number used to identify a mobile phone subscriber. Phrased slightly differently, when a user switches phones, the IMSI number, associated with the SIM card remains the same, but the new phone will have a different IMEI number. This IMEI information is typically retain by the carrier that sold the phone to the mobile phone user MU. As illustrated in FIG. 3A, this user identification information is contained in a data base often referred to as an Equipment Identity Register (EIR) which may be used to contain the MSISDN information. For purposes of clarity, this information could be contained in another type of data base and is not limited to storage in the EIR. The EIR storing MSISDN information could be a server, a data center, a hard drive or other devices for storing large quantities of information. The MSISDN information may be accessed through the internet, via landlines or other ways to remotely access information contained in a remote data base. Preferably, the connection between the data base containing the mobile phone user's information would be secure and accessed through the internet. However, it is possible that a subset of the data base could be stored on a hard drive carried by the police vehicle. To be more clear, IMEI, IMSI, and MSISDN numbers may be thought of as associated information that is associated with the cell phone MS and/or its owner/user MU. The IMEI number has been used by Chinese police to track demonstrators in 2022 and the Indonesian police were able to gather information about the Bali Bombers after a forensic crime scene investigator found the tiny fragment of a Nokia 5110 mobile phone used in the bombing of the US consulate. The fragment contained the Nokia 5110 mobile phone's 15-digit serial number, also referred to as the IMEI number. The mobile phone carrier's records indicated the name of the person that had purchased the Nokia phone. However, these uses of IMEI information were not in real time. In the case of the Bali bombing, it took investigators an extended period of time, a period of at least several months, to locate the Nokia 5110's purchaser. Phone records indicated that the Nokia 5110 used to trigger the US consulate blast had received one final call from a telephone number identified in the Indonesian telecom carrier Telkomsel's data. This helped Indonesian National Police trace the owner of that number, hunting him down through a Bali retailer. However, in these instances, the identification of the owner of the phone was not done in real time and involved many hours of police work before the owner was identified. While valuable in ultimately resolving the 2002 Bali bombing crime, the information was not available in real time.

### SUMMARY OF THE INVENTION

A detection device for determining the number of passengers in a vehicle, comprising: an antenna for receiving a signal from an electronic device; a device for determining the number of electronic devices found within the vehicle using the signal from the electronic device located within the vehicle; and, a transceiver configured to communicate the number of electronic devices to a recipient.

A method of determining the number of passengers in a vehicle, comprising: detecting the number of electronic devices found within the vehicle using the signal from the electronic device located within the vehicle; and, communicating the number of electronic devices to a recipient.

A method of determining the number of cell phones present in a vehicle to a user, comprising: collecting associated information from any device present in the vehicle; determining the number of cell phones present in the vehicle; and, communicating the number of cell phones to the user.

A processor readable storage medium contained within a portable electronic device, the storage medium containing a set of processor executable instructions that cause the portable electronic device to: collect associated information from any device present in the vehicle; determine the number of cell phones present in the vehicle; and, communicate the number of cell phones to the user.

These and other embodiments will be more fully appreciated from the description below.

### BRIEF DESCRIPTION OF THE DRAWINGS

FIG. 1 illustrates a forward-looking infrared (FLIR) camera mounted on a conventional police helicopter detecting a person's infrared radiation, also known as body heat.

FIG. 2 illustrates a FLIR camera, a glass wall, and a person.

FIG. 3A illustrates the typical components of a conventional mobile phone network.

FIG. 3B illustrates the layout of aspects of a typical conventional mobile phone network and is a stylized environmental view illustrating cell towers and the ubiquity of cell towers and cell phones throughout the modern world.

FIG. 4A illustrates a plan view of a passenger detection apparatus used in conjunction with a helicopter.

FIG. 4B illustrates a plan view of a passenger detection apparatus used in conjunction with a law enforcement vehicle.

FIG. 4C illustrates an enlarged view of the passenger detection device that is used in conjunction with the helicopter.

FIG. 4D illustrates an enlarged view of the passenger detection device that is used in conjunction with the law enforcement vehicle.

FIG. 4E illustrates a plan view of a hand-held passenger detection device used by a law enforcement officer.

FIG. 4F illustrates a plan view of a drone mounted passenger detection device.

FIG. 5A illustrates an environmental view of a passenger detection device used in conjunction with a helicopter and the helicopter's FLIR apparatus.

FIG. 5B illustrates an environmental view of a passenger detection device used in conjunction with a law enforcement vehicle.

FIG. 5C illustrates an embodiment of an antenna for receiving cell phone signals generally known as an LPDA antenna.

FIG. 5D illustrates another embodiment of an antenna for receiving cell phone signals generally known as a parabolic antenna.

FIG. 5E illustrates a second embodiment of an antenna for receiving cell phone signals generally known as a “pringles” antenna.

FIG. 6 illustrates a flow chart of an embodiment of a method of using the passenger detection apparatus.

FIG. 7 illustrates a flow chart of a first alternative embodiment of a method of using the passenger detection apparatus.

FIG. 8 illustrates a flow chart of a second alternative embodiment of a method of using the passenger detection apparatus.

FIG. 9 illustrates a flow chart of a third alternative embodiment of a method of using the passenger detection apparatus.

FIG. 10 illustrates a flow chart of a fourth alternative embodiment of a method of using the passenger detection apparatus.

FIG. 11A illustrates a flow chart of a fifth alternative embodiment of a method of using the passenger detection apparatus.

FIG. 11B illustrates a flow chart of a sixth alternative embodiment of a method of using the passenger detection apparatus.

FIG. 12 illustrates information gathered concerning IMEI information may be performed locally by one or more processors.

FIG. 13 illustrates a schematic block diagram illustrating an exemplary embodiment of a server computing system executing an implementation of an app.

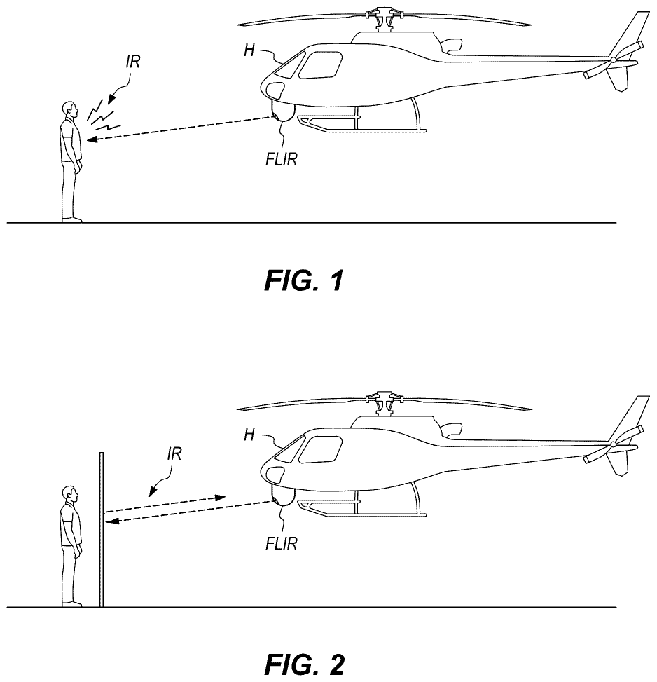

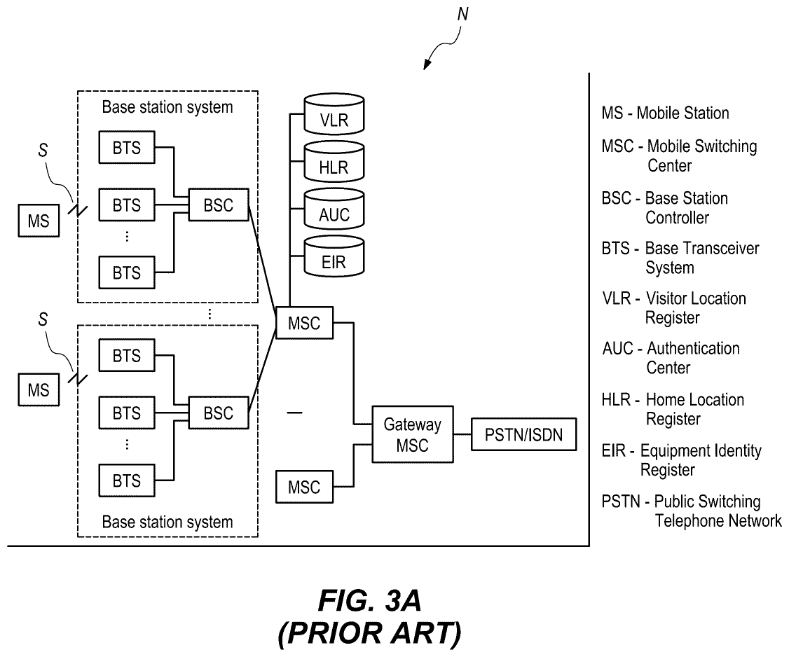

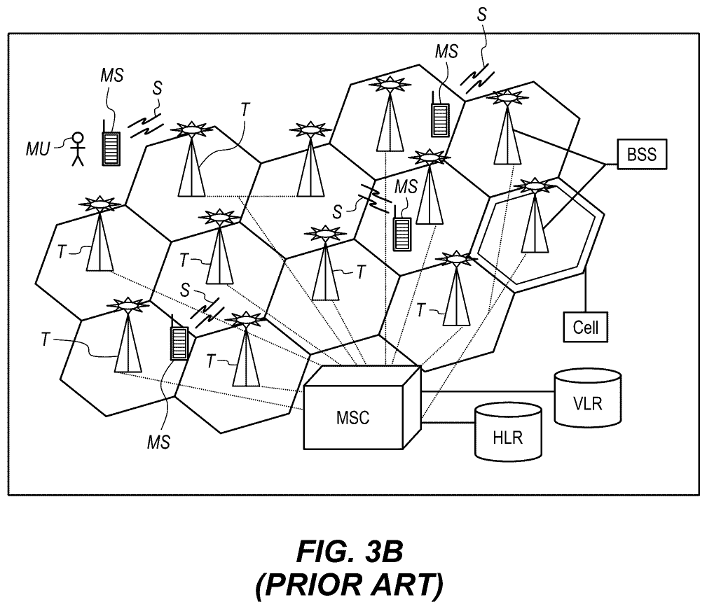

### DESCRIPTION OF THE PREFERRED EMBODIMENTS

Corresponding reference numbers indicate corresponding parts throughout the several views of the drawings and specification.

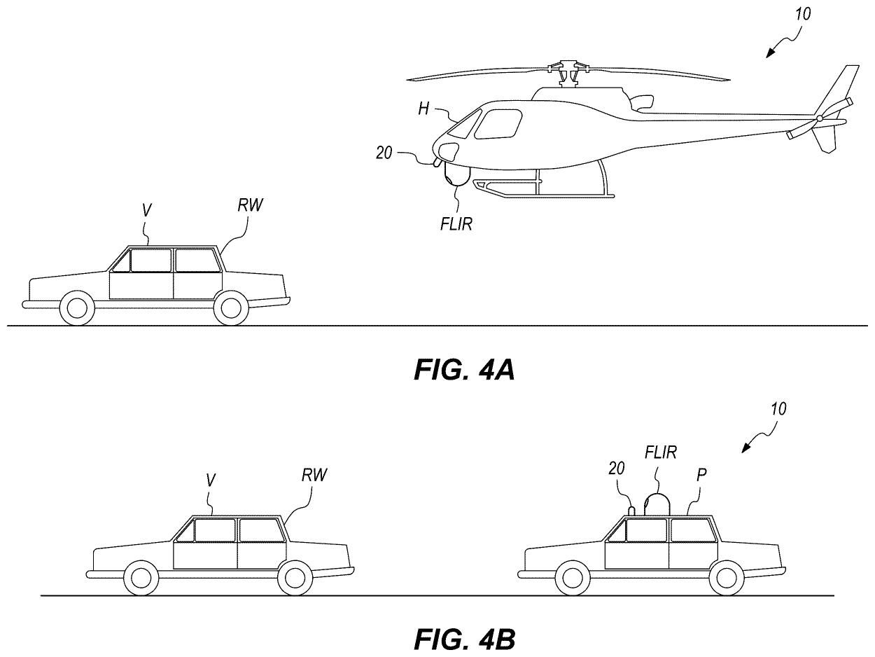

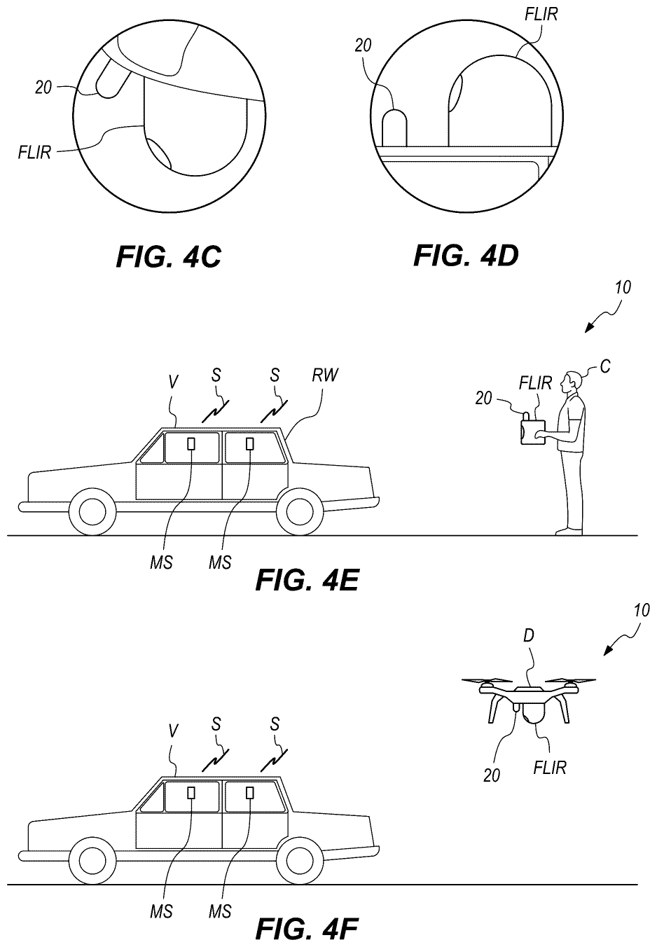

FIG. 4A illustrates an environmental view of a passenger detection apparatus 10 mounted to a police helicopter H. Police helicopter H may be observing vehicle V in conjunction with police cruiser P. Helicopter H and cruiser P may use passenger detector apparatus 10, respectively. Phrased differently, either or both police helicopter H and police cruiser P may use passenger detection apparatus 10.

FIG. 4A illustrates passenger detector apparatus 10 deployed in conjunction with an FLIR unit. FIG. 4B illustrates passenger detector apparatus 10 deployed on or in a police cruiser P. FIG. 4C illustrates a close up of passenger detector apparatus 10 and more specifically of antenna 20. FIG. 4D illustrates a close up of passenger detector apparatus 10 and more specifically of antenna 20. FIG. 4E illustrates a hand held passenger detection apparatus 10 employing antenna 20. FIG. 4F illustrates a passenger detection apparatus 10 deployed with a drone D and employing antenna 20.

Cell phones are ubiquitous in the modern world. Observers believe that in 2024 there are more than 300 million cell phones in the United States alone. According to the World Economic Forum, the world has more than 8.5 billion cell phones. Cell phone penetration, the percentage of the population that owns a cell phone, is in excess of 96% in the United States. Among 18-29 year-old Americans, cell phone penetration exceeds 99% and virtually 100% of young people own at least one cell phone.

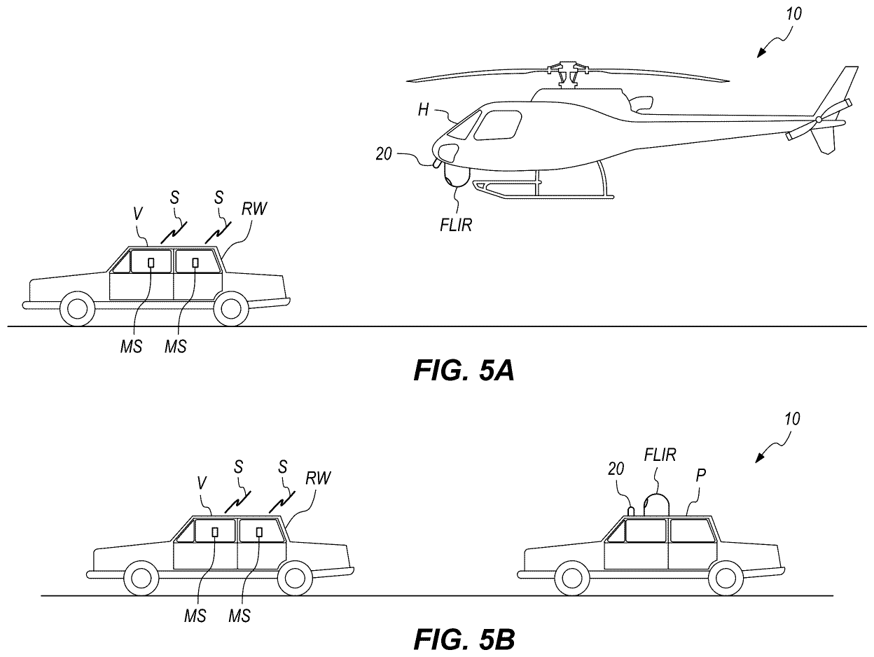

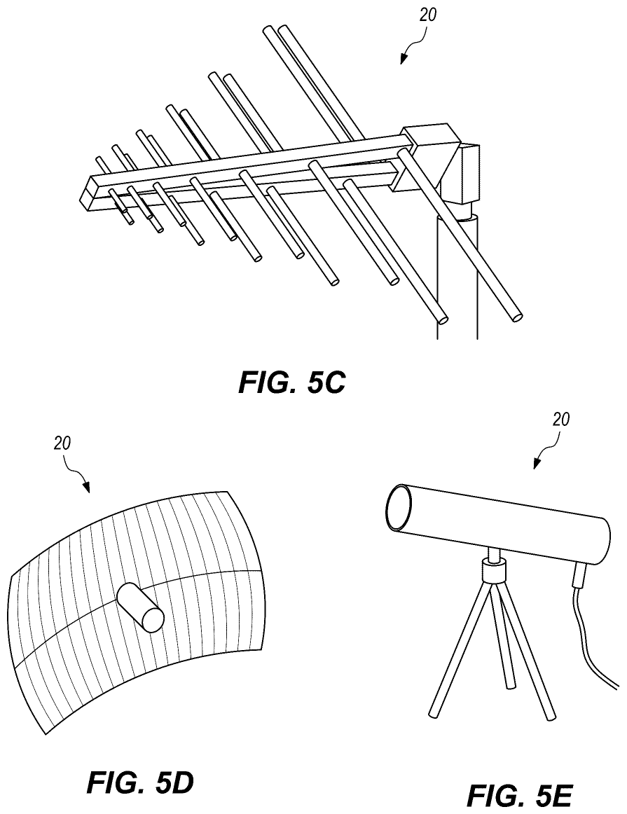

As discussed above, a law enforcement officer that is approaching or pursuing a vehicle V, particularly at night, will have no idea how many occupants are in vehicle V. FIGS. 5A and 5B illustrate an antenna 20 mounted on a police helicopter H or a police cruiser P that could receive the signal S from the cell phones MS of the occupants of vehicle V. It is known that cell phones MS emit an omnidirectional signal S and that they do so approximately every seven seconds, even during the time the cell phone MS is not in use to talk or text. This signal S includes information including the phone's IMEI and IMSI, which can be used to identify the number of cell phones MS inside the vehicle V and also, potentially, the identities of the occupants/mobile user MU of vehicle V.

In order to aim the antenna 20 and receive the signal S emitted by the cell phones MS within vehicle V, a directional antenna is preferable. Among the directional antennas potentially suitable to receive cell phone signals S are Yagi-Uda antennas, log-periodic antennas, parabolic antennas, and corner reflector antennas. A Pringles antenna is also a highly focused directional antenna that is suitable for this task.

As a non-limiting example, a Yagi-Uda antenna design that is suitable for receiving signal S is illustrated in FIG. 5C. The jagged dashed lines represent the radio signal emissions S from cell phones MS that are present in vehicle V. As a non-limiting example, assuming a diameter of 1 meter for antenna 20, the focal length is 0.4 meters, i.e., 400 mm. The depth of the parabola is 156.25 mm, for broadband operation of 1800 MHZ to 2900 MHZ, a Log-Periodic Dipole Array (LPDA) is an effective feed antenna. The longest dipole length is approximately 83.4 mm and the shortest dipole length is 51.7 mm. The number of elements is preferably nine. A non-limiting example of an LPDA antenna is illustrated in FIG. 5C.

FIG. 5D illustrates a parabolic antenna 20 potentially for use with helicopter H or another vehicle, i.e. hand held, drone mounted or vehicle mounted. The parabolic antenna could have a reflector diameter of about 150 centimeters, a focal length of about 52.5 centimeters, and a feed horn aperture of about 13 centimeters.

FIG. 5E illustrates a “Pringles” antenna 20. This type of antenna is a highly focused directional antenna that can be made from a Pringles chip can.

However, alternatively, multiple antennas 20 could be used to optimize signal reception. However, as the antenna is purposed to receive the IMEI and/or IMSI number/information of cell phone MS, the quality and clarity of the signal S is not required to be of substantially equivalent or similar to the quality of a human conversation transmitted and/or received by cell phone MS.

There are two general high-level tracking approaches to direct antenna 20 such that it can receive cell phone signal S from cell phones MS contained in vehicle V as the cell phone signal S is emitted and passes outside windows W of vehicle V. The first one is to choose an area of interest, such as vehicle V's rear window RW on the very first frame and then just track it in all the following frames. The second one is to use the algorithms that allow connecting the results of object detection in one line (for example, approaches like Tracking via Generalized Maximum Multi Clique Problem or Graphical Social Topology Model for Multi-Object Tracking). Irrespective of the tracking approach used, antenna 20 is directed such that it will receive the signals S of the cell phones MS of the occupants of vehicle V. Typically, a police cruiser P will follow behind a vehicle V that it is following. However, a police helicopter H may orbit the vehicle V. Similarly, as illustrated in FIG. 4E, a police officer C may track a vehicle as it approaches, or as it is receding. Alternatively, the officer C may use passenger detection apparatus 10 at a check point or as the vehicle V is passing to determine the number of passengers. As a further alternative, FIG. 4F illustrates a plan view of a drone D mounted passenger detection device 10. To be clear, it is not required that the FLIR is in use and the FLIR is not required to operate passenger detection apparatus 10.

In addition to cell phones MS, an occupant/passenger may have other radiation/signal S emitting devices such as a tablet, a smart watch, a laptop or the like. A standard cell phone MS, is known to be capable of communicating with a cell tower T that may be up to 45 miles (72.45 kilometers) away. The tablet, smart watch or laptop that emit a signal S, typically communicate with a network or, in the case of a smartwatch, a cell phone MS. This generally means that these devices emit significantly lower levels of radiation than a cell phone MS. In a preferred embodiment, the information received by antenna 20 will be ranked by signal strength, i.e., with the strongest signal strength likely emitted by a cell phone MS, rather than a device emitting a signal that is less strong than that emitted by a cell phone MS, i.e., a tablet, smart watch or laptop or a similar device.

The majority of tracking approaches are based on the same set of algorithms that were improved and modified for a particular purpose. The basic algorithms are KCF (kernelized correlation filter), TLD (Tracks, Learns and Detects), Minimum Output Sum of Squared Error (MOSSE) filter, Struck (Structured Output Tracking with Kernels), Median Flow Tracker (this algorithm fails to track objects that move fast or quickly change their appearance), and others. Irrespective of the method used or the area of vehicle V tracked, it is important that the radiation/radio emissions/signal S from cell phones MS can be received by antenna 20. Preferably, antenna 20 would use the same tracking system employed by the FLIR system in use by vehicle V, helicopter H, or drone D or when hand held (FIG. 4E).

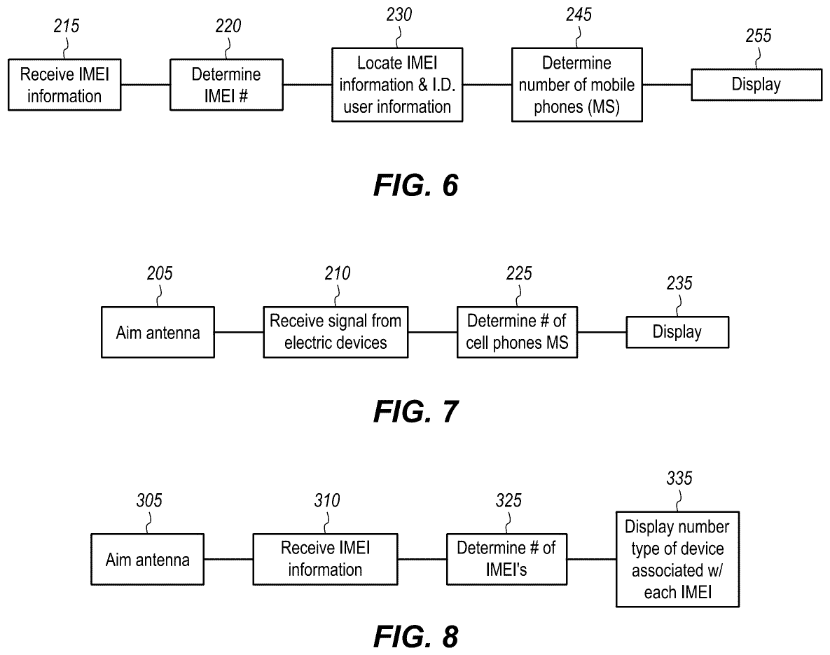

FIG. 6 illustrates a flow chart of the preferred process of collecting cell phone MS signals S and using it to determine the number of cell phones, and likely the number of occupants of a vehicle V. Antenna 20 is aimed at the window W of vehicle V. Typically, antenna 20 will be aimed at a rear window RW, as the police car P and/or helicopter H will be in pursuit of vehicle V. However, antenna 20 may be directed at other windows of vehicle V. At box 215, antenna 20 receives IMEI information for any cell phone MS. At box 220, the IMEI information is determined. At box 230, using IMEI information, identifying information about the owner of the cell phone MS is determined. At box 245, the number of cell phones MS in vehicle V is determined. At box 255, this information is conveyed to the recipient. Preferably, the information at box 255 is conveyed by a transceiver. For example, the information concerning the number of cell phones MS could be communicated by being displayed on a screen or conveyed audibly. It is expected that the recipient will be a law enforcement officer or other law enforcement personnel. The recipient could be a flight officer or a pilot of the police helicopter H or a law enforcement officer riding in police car P or the recipient could be at another location and radio or otherwise communicate the information to police car P or police helicopter H.

FIG. 7 illustrates a flow chart of an alternative embodiment of the process of collecting cell phone MS signals S and using it to determine the number of cell phones, and therefore likely the number of occupants, of a vehicle. At box 205, antenna 20 is aimed at the window W of vehicle V. At box 210, antenna 20 receives IMEI information from any cell phone MS detected inside by antenna 20. At box 225, the number of cell phones MS is determined. At box 235, the number of cell phones MS is displayed on a screen or conveyed audibly. Preferably, if the number of cell phones MS is displayed on a screen, the signal strength may also be displayed to assist in determining if signal S has been emitted by a cell phone MS or another device located in vehicle V. Preferably, the information at box 235 is conveyed by a transceiver.

It is also known that a number of electronic devices also have IMEI information associated with the particular device. For example, an Apple watch might be paired with an Apple phone and each would have its own unique IMEI. However, the presence of two unique IMEI numbers likely does not indicate that there are two individuals in vehicle V.

FIG. 8 illustrates a flow chart of another embodiment of the process of collecting cell phone signals S and using it to determine the number of cell phones, and therefore likely the number of occupants, of a vehicle. At box 305, antenna 20 is aimed at the window W of vehicle V. At box 310, antenna 20 receives IMEI information from any cell phone MS or similar device such as a tablet, smart watch or laptop or similar device detected inside vehicle V by antenna 20. At box 325, the number of cell phones MS is identified and also IMEI information associated with other devices detected. At box 335, the number of cell phones MS is displayed on a screen or conveyed audibly and also the number of devices with a unique IMEI, which are not necessarily cell phones MS. Alternatively, the number of devices with unique IMEI information could be displayed as is preferable for the person viewing the information or hearing the information. In a preferred embodiment, the IMEI of each device could be ranked by signal strength to differentiate between cell phones MS and the mobile user MU's associated gadgets such as tablets, smart watches and/or laptops or similar devices. Preferably, the information at box 335 is conveyed by a transceiver.

Referring again to FIG. 8, disposable cell phones, also known as “burner” phones do not defeat the present apparatus and method because cell phones MS each have a unique IMEI; even if, no person is associated with the particular IMEI. To be clear, burner phones are frequently purchased for cash and therefore there is no ownership record of the burner phone.

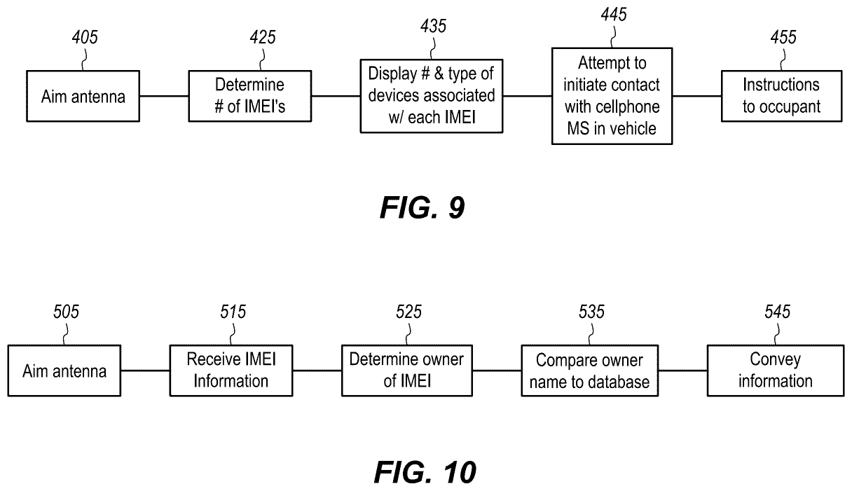

FIG. 9 illustrates a flow chart of another embodiment of the process of collecting cell phone signals S and using it to determine the number of cell phones, and therefore likely the number of occupants, of a vehicle and using this information to attempt to contact a person inside the vehicle V possessing the device. At box 405, antenna 20 is aimed at the window W of vehicle V. At box 425, antenna 20 receives IMEI information from any cell phone MS or similar device such as an Apple watch or iPad or similar device detected inside by antenna 20. At box 435, the number of cell phones MS is identified and also IMEI information associated with other devices detected. At box 435, the number of cell phones MS is displayed on a screen or conveyed audibly and also the number of devices with a unique IMEI, which are not necessarily cell phones MS. Preferably, the information at box 435 is conveyed by a transceiver. Alternatively, the number of devices with unique IMEI information could be displayed as is preferable for the person viewing the information or hearing the information. At box 445, law enforcement can attempt to telephone the cell phone MS associated with the unique IMEI for cell phone MS. This is desirable because communication between law enforcement personnel and vehicle V's occupant(s)/driver can improve the chances of diffusing a potentially dangerous situation. For example, a father driving his pregnant wife who is in labour might not slow or stop for law enforcement due to his concern over the urgency of her delivery. If this situation were known to law enforcement, this would likely defuse a potentially dangerous situation. Similarly and depending on the situation, law enforcement could use cell phone MS to communicate the location of a nearby medical facility or arrange for paramedics to meet vehicle V if a medical facility is not sufficiently nearby. At box 445, a person can attempt to communicate with the occupants of vehicle V. At box 455, the person can provide instruction to the occupants of vehicle V.

FIG. 10 illustrates a flow chart of another embodiment of the process of collecting cell phone signals S and using it to determine the number of cell phones, and therefore likely the number of occupants, of a vehicle V. At box 505, antenna 20 is aimed at the window W of vehicle V. At box 515, antenna 20 receives IMEI information from any cell phone MS or similar device such as an Apple watch or iPad or similar device detected inside vehicle V by antenna 20. At box 525, the number of cell phones MS is identified and also IMEI information associated with other devices detected, i.e., the owner of the device with a particular IMEI is determined. At box 535, the name, if known, of each cell phone MS is compared to one or more data bases to determine if the person associated with the IMEI is of interest to law enforcement. At box 545, the number of cell phones MS is displayed on a screen or conveyed audibly and also the number of devices with a unique IMEI, which are not necessarily cell phones MS is displayed. Alternatively, the number of devices with unique IMEI information could be displayed as is preferable for the person viewing the information or hearing the information.

Returning to discussion of box 535, for example, the (NCIC) National Crime Information Center's data base contains a data base for crime-related information. At box 545, information from the NCIC or other database could be displayed to law enforcement. Preferably, the information at box 455 is conveyed by a transceiver. The present apparatus and method are not limited to purely the NCIC data base and other data bases could be searched or interrogated to gather pertinent information concerning the occupant(s) of vehicle V. For further example, Texas has a data base of people lawfully permitted to carry a concealed weapon. These lawful concealed carry persons have been vetted by the State of Texas and are highly unlikely to be involved in criminal activity. However, they are highly likely to be carrying a concealed weapon. Both pieces of information are useful to law enforcement when attempting to safely approach the vehicle V.

Interestingly, vehicles V may also have their own IMEI. In other words, vehicle V may have its own unique identifying IMEI number. This is increasingly true as vehicles V are increasingly connected to the internet and other communications networks. It is believed that this development has occurred because vehicle manufacturers increasingly are collecting data concerning the operation and safety of individual vehicles. Increasingly, vehicles V now require software updates to regulate and optimize their operation. This use of software to regulate and optimize vehicle operation also permits remote control of vehicle V's components. For example, in the case of a leased vehicle, if the person leasing the vehicle fails to make his or her lease payment in a timely fashion, the owner of the lease may activate a “kill switch” that disables the operator's ability to operate the car by disabling the starter motor and/or key fob. These “kill switches” are generally known as starter interrupter devices. Similarly, a vehicle that is in motion could be slowed and stopped by remotely instructing the fuel pump to slow pumping and, ultimately stop pumping, of fuel. This would permit law enforcement to prevent a vehicle from fleeing pursuit without requiring use of road spikes or barriers or use of the Precision Immobilization Technique (PIT). All of these three techniques may be problematic because they may endanger the vehicle's occupants or the law enforcement officers engaged in the pursuit and attempting to immobilize the vehicle.

In a preferred embodiment, a software application, commonly known as an “app” could be used by vehicle V's software, or the software of the police vehicle/helicopter etc. . . . to collect information about the vehicles occupants by gathering data about the occupants using the methods described above, i.e., collecting and transmitting the IMSI and IMEI of the occupants of the car and determining the occupants of a car even before law enforcement interacts with or is pursuing the vehicle V. In a similar fashion, data from the passenger seat weight sensors could also provide a potential way of determining the number of occupants of vehicle V. For example, in the same way that the strain gauges in a passenger seat determine if a threshold weight has been exceeded, thereby indicating that a passenger is occupying the seat, the app could determine if a seat in vehicle V is occupied. This occurs when the seat employs a weight sensor that has a case mounted between a seat pan and a seat component. One or more strain gauge resistors are mounted in the seat's case. The resistors generate an electrical signal in response to the case being stressed by the weight of the seat occupant. In response to this electrical signal indicating that there is weight present on the seat, a sensor in the seat belt buckle determines if the seat belt is buckled. If the car seat is buckled, there is a substantial likelihood that the seat is occupied. In another preferred embodiment, the app could collect and transmit the reading from the strain gauge resistors to allow law enforcement to determine the weight of the seats occupant. While not guaranteed, a large weight might indicate a large man who is likely to be more physically able to more forcefully resist law enforcement.

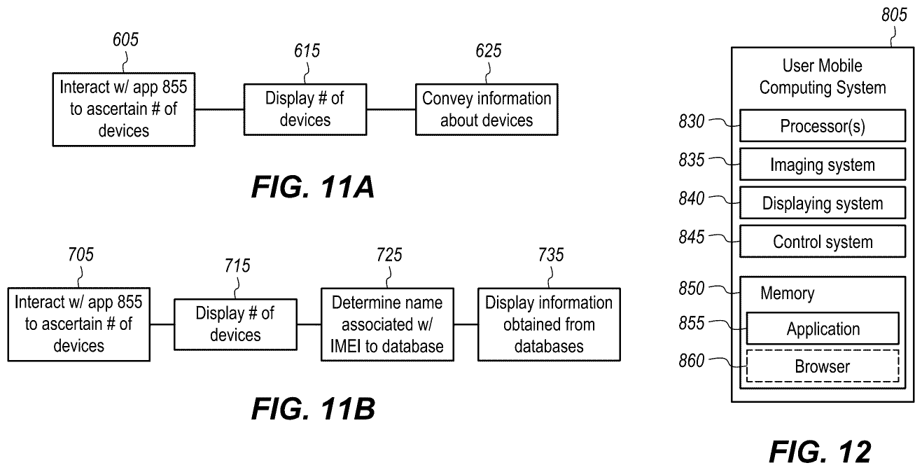

FIG. 11A illustrates a flow chart of another embodiment of the process to determine the number of cell phones MS present in a vehicle and using it to determine the number of cell phones, and therefore likely the number of occupants, of a vehicle V. At box 605, a user interacts with an app to access information collected by vehicle V's sensors that collect IMEI information from any cell phone MS or similar device such as an Apple watch or iPad or similar device. The user's interaction can be through an antenna 20 or through an internet connection established by accessing an internet connection with vehicle V. At box 615, the number of cell phones MS is identified and also IMEI information associated with other devices detected and communicated to the user. In the preferred embodiment, the information is displayed visually. However, the information can be conveyed audibly or via text as illustrated by box 625.

FIG. 11B illustrates a flow chart of another embodiment of the process to determine the number of cell phones MS present in a vehicle and using it to determine the number of cell phones MS, and therefore likely the number of occupants, of a vehicle V. At box 705, a user interacts with an app to access information collected by vehicle V's sensors that collect IMEI information from any cell phone MS or similar device such as an Apple watch or iPad or similar device. The user's interaction can be through an antenna 20 or through an internet connection established by accessing an internet connection with vehicle V. At box 715, the number of cell phones MS is identified and also IMEI information associated with other devices detected and is communicated to the user. In the preferred embodiment, the information is displayed visually. However, the information can be conveyed audibly or via text. At box 725, the name, if known, of each cell phone MS is compared to one or more data bases to determine if the person associated with the IMEI is of interest to law enforcement. For example, the (NCIC) National Crime Information Center's data base contains a data base for crime-related information. At box 735, information from the NCIC, or other data bases, could be displayed to law enforcement. The present apparatus and method are not limited to purely the NCIC data base and other data bases could be searched or interrogated to gather pertinent information concerning the occupant(s) of vehicle V.

In the embodiments depicted above, and as illustrated in FIG. 12, application 855 the information gathered concerning IMEI information is performed locally by one or more processors 830 via application 855 executed in memory 850. In various embodiments, some or all of the processing maybe handled by one or more remote server computing systems executing an embodiment of app 855.

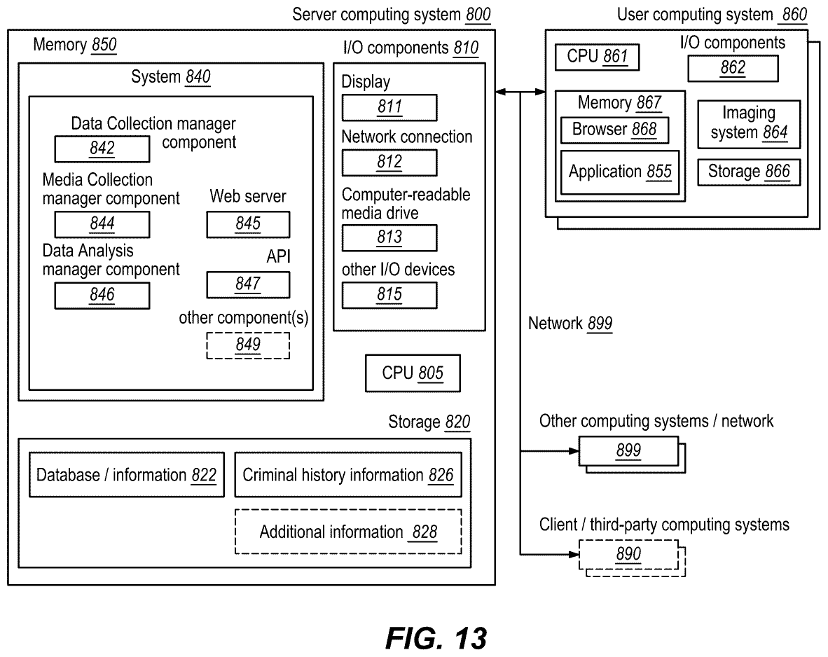

Further, as illustrated in FIG. 13, which is a block diagram illustrating an embodiment of a server computing system 800 executing an implementation of the app 855. The server computing system 800 and app 855 may be implemented using a plurality of electronic circuits that, when in combined operation, are suitable for performing and configuring to perform at least some of the techniques described.

In the illustrated embodiment, the server computing system 800 includes one or more hardware central processing units (CPU) or other processors 805, various input/output (I/O) components 810, storage 820, and memory 850, with the illustrated I/O components including a display 811, network connection 812, a computer readable media drive 813, and other I/O devices 815 (e.g. key boards, mice or other pointing devices, microphones, speakers, GPS, receivers and the like, etc.). The server computing system 800 and executing app 855 may communicate with other computing systems via one or more networks/other computer systems 899 (e.g. Internet, one or more cellular networks, etc.), such as app 855, third-party computer systems 890 and other computer systems 899. In the illustrated embodiment, an embodiment of the app 855 executes in memory 850 in order to perform at least some of the techniques discussed to execute software instructions of the system 840 in a manner that configures the processors 805 and computing system 800 to perform automated operations that implement the described techniques. The illustrated embodiment of the app 855 includes data collection management component 842, media collection manager component 844, data analysis manager component 846, web server 845, API 847, and (optionally) other programs and components 849. As part of such operations, the app 855, components thereof, and/or other operational programs or components 849 executing in memory 850 may store and/retrieve various types of data, including in the example database data structures of storage 820. In this example, the data used may include various types of IMEI/IMSI information in the database (DB) 822, various types of criminal history information in DB 826, and/or various types of additional information 828, such as various analytical information related to the likely number and identity of occupants of vehicle V.

Some or all of the user computing system 860, client computing systems 890, and other computer systems 899 may similarly include some or all of the types of components illustrated for server computing system 800. As non-limiting examples, the app 855/server computing system 800 may include hardware CPUs 861, I/O components 862, storage 866, and memory 867. In the depicted embodiments, the computer system 860 may also include an imaging system 864, and both a browser 868 and app 855 are executed within memory 867.

It will be appreciated that computing system 800 and other systems and devices that are included within FIG. 13 are merely illustrative and are not intended to limit the scope of the present disclosure. The systems and/or devices may instead each include multiple interacting computer systems or devices and may be connected to other devices that are not specifically illustrated including via Bluetooth communication or other direct communication, through one or more networks such as the Internet, via the Web, or via one or more private networks (e.g. mobile communication networks, etc.). More generally, a device or other computing system may comprise any combination of hardware that may interact and perform the described types of functionality, optionally when programmed or otherwise configured with particular software instructions and/or data structures, including without limitation desktop or other computers (e.g. tablets, slates, etc.), database servers, network storage devices and other network devices, smart phones and other cell phones, consumer electronics, wearable devices, digital music playing devices, handheld devices, PDA's, wireless phones, Internet appliances, and various other consumer products that include appropriate communications capabilities. In addition, the functionality provided by the illustrated app 855 may in some embodiments be distributed in various components other than those specifically illustrated. Similarly, in some embodiments, some of the functionality of the app 855 may not be provided and/or other additional functionality may be available. In addition, in certain implementations, various functionality of the app 855 may be provided by third-party partners. For example, data collected by the app 855 may be provided to a third party for analysis.

It will also be appreciated that, while various items are illustrated as being stored in memory or on storage while being used, these items or portions of them may be transferred between memory and other storage devices for purposes of memory management and data integrity. Alternatively, in other embodiments some or all of the software components and/or systems may execute in memory on another device and communicate with the illustrated computing systems via inter-computer communication. Thus, in some embodiments, some or all of the described techniques may be performed by hardware means that include one or more processors and/or memory and/or storage when configured by one or more software programs (e.g., the app 855 and/or client software executing on user computing systems 860 and/or client computing devices 890/899) and/or data structures, such as by execution of software instructions of the one or more software programs and/or by storage of such software instructions and/or data structures. Furthermore, in some embodiments, some or all of the systems and/or components may be implemented or provided in other manners, such as by consisting of one or more means that are implemented at least partially in firmware and/or hardware (e.g., rather than as a means implemented in whole or in part by software instructions that configure a particular CPU or other processor), including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the components, systems and data structures may also be stored (e.g., as software instructions or structured data) on a non-transitory computer-readable storage mediums, such as a hard disk or flash drive or other non-volatile storage device, volatile or non-volatile memory (e.g., RAM or flash RAM), a network storage device, or a portable media article (e.g., a DVD disk, a CD disk, an optical disk, a flash memory device, etc.) to be read by an appropriate drive or via an appropriate connection. The systems, components and data structures may also in some embodiments be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of the present disclosure may be practiced with other computer system configurations.

While the invention has been illustrated and described in detail in the drawings and description, the same is to be considered as an illustration and is not limited to the exact embodiments shown and described. All equivalents, changes and modifications that come within the spirit of the invention are also protected by the claims that are set forth below.

What i claim is:

1. A detection device for determining the number of passengers in a vehicle, comprising:
(a) an antenna for receiving a signal from an electronic device;
(b) a device for determining the number of electronic devices found within the vehicle using the signal from the electronic device located within the vehicle; and,
(c) a transceiver configured to communicate the number of electronic devices to a recipient.

2. The detection device of claim 1, wherein, the antenna is a directional antenna.

3. The detection device of claim 2, wherein, the directional antenna is selected from the group consisting of an LPDA antenna, a parabolic antenna, and a Pringles antenna.

4. The detection device of claim 1, wherein, the device for determining the number of electronic devices found within a vehicle is configured to receive associated information from the electronic devices within the vehicle.

5. The detection device of claim 4, wherein, the associated information is an IMEI number, an IMSI number, or a MSISDN number.

6. The detection device of claim 1, wherein the detection device is hand-held, mounted on a police helicopter, mounted on a drone, or mounted on a police vehicle.

7. A method of determining the number of passengers in a vehicle, comprising:
(a) detecting the number of electronic devices found within the vehicle using the signal from the electronic device located within the vehicle; and,
(b) communicating the number of electronic devices to a recipient.

8. The method of determining the number of passengers in a vehicle of claim 7, further comprising: aiming an antenna at a window of the vehicle to receive a signal emitted by the electronic devices found within the vehicle.

9. The method of determining the number of passengers in a vehicle of claim 7, further comprising: determining the associated information for the electronic devices within the vehicle from the signal received.

10. The method of determining the number of passengers in a vehicle of claim 9, wherein the associated information is the IMEI, IMSI or MSISDN numbers associated with the electronic device.

11. The method of determining the number of passengers in a vehicle of claim 10, further comprising: determining the owner of the electronic devices within the vehicle from the IMEI, IMSI or MSISDN numbers associated with the respective electronic device.

12. A method of determining the number of cell phones present in a vehicle to a user, comprising:
(a) collecting associated information from any device present in the vehicle;
(b) determining the number of cell phones present in the vehicle; and,
(c) communicating the number of cell phones to the user.

13. The method of determining the number of passengers in a vehicle of claim 12, further comprising: aiming an antenna at a window of the vehicle to receive a signal emitted by the electronic devices found within the vehicle.

14. The method of determining the number of passengers in a vehicle of claim 12, further comprising: determining the associated information for the electronic devices within the vehicle from the signal received.

15. The method of determining the number of passengers in a vehicle of claim 14, wherein the associated information is the IMEI, IMSI or MSISDN numbers associated with the electronic device.

16. The method of determining the number of passengers in a vehicle of claim 15, further comprising: determining the owner of the electronic devices within the vehicle from the IMEI, IMSI or MSISDN numbers associated with the respective electronic device.

17. The method of determining the number of passengers in a vehicle of claim 13, wherein the antenna aimed at the window of the vehicle is a directional antenna.

18. The method of determining the number of passengers in a vehicle of claim 13, wherein the directional antenna aimed at the window of the vehicle is selected from the group consisting of an LPDA antenna, a parabolic antenna, and a Pringles antenna.

19. A processor readable storage medium contained within a portable electronic device, the storage medium containing a set of processor executable instructions that cause the portable electronic device to:
collect associated information from any device present in the vehicle;
determine the number of cell phones present in the vehicle; and,
communicate the number of cell phones to the user.
